(19) United States
(12) Patent Application Publication
(10) Pub. No.: US 2007/0288716 A1
(43) Pub. Date: Dec. 13, 2007

(54) Memory system with a retiming circuit and a method of exchanging data and timing signals between a memory controller and a memory device

(75) Inventors: Edoardo Prete, Munchen (DE); Anthony Sanders, Haar (DE); Maurizio Skerlj, Munchen (DE); Ulrich Lange, Augsburg (DE)

Correspondence Address: PATTERSON & SHERIDAN, LLP;Gero McClellan / Infineon / Qimonda, 3040 POST OAK BLVD.,, SUITE 1500, HOUSTON, TX, 77056, US

(73) Assignee: INFINEON TECHNOLOGIES AG, Munchen (DE)

(21) Appl. No.: 11/449,855

(22) Filed: Jun. 9, 2006

(51) Int. Cl. G06F 13/00

(52) U.S. Cl. 711/167

(57) ABSTRACT

The present invention refers to a memory system with a controller and a memory device with a communication channel with a data path and a timing path coupling the controller with the memory device. The communication channel has different propagation times for the data path and the timing path exchanging a information signal and a timing signal between the controller and the memory device. The timing signals are used for determining the value of the information signal, and a retiming circuit that is connected with the communication channel compensates, depending on a compensation signal on an input, the delay between the data path and the timing path for exchanging a information signal and a timing signal between the controller and the memory device.

### TECHNICAL FIELD OF THE INVENTION

The present invention relates to a memory system with a controller and a memory device and a method of exchanging data and timing signals between a memory controller and a memory device.

### BACKGROUND OF THE INVENTION

Memory systems may comprise a memory controller and at least one memory device. In conventional systems the memory controller is connected with several memory devices. For different applications it is advantageous to control the access to memory devices and to use an arbiter that decides who and at which times the memory device may be used for storing data or may be used for reading data from the memory device. Measures have to be taken to prevent modifying the system in order to have free access to the memory devices without the arbiter. Such a system may be of advantage in a memory subsystem in a computer constituted by a memory controller and a set of memory devices that are connected by a communication channel.

A conventional system may use an encryption unit and a deencryption unit that is under control of the arbiter. This system may be effective but presents some drawbacks as the encryption and the deencryption cost latency and the encryption and the deencryption functionality has to be added on the functionality of the memory device. This implies that this solution may not be suitable for a mass production of memory devices and therefore rises the costs.

### SUMMARY OF THE INVENTION

Embodiments of the present invention provide an improved memory system and an improved method of exchanging data between a memory controller and a memory device with the controller.

More particularly, embodiments of the present invention provide a memory system with a controller and a memory device with a retiming circuit that controls the access to the memory device.

In one embodiment of the invention, there is a memory system with a controller and a memory device; with a communication channel with a data path and a timing path coupling the controller with the memory device; whereby the communication channel having different propagation times for the data path and the timing path exchanging an information signal and a timing signal between the controller and the memory device, whereby the timing signal is used for determining the value of the information signal; comprising a retiming circuit that is connected with the communication channel, whereby the retiming circuit compensates depending on a compensation signal on an input of the retiming circuit the delay between the data path and the timing path for sending an information signal and a timing signal from the controller to the memory device.

In another embodiment of the invention, there is a memory system with a controller and a memory device; with a communication channel with a data path and a timing path coupling the controller with the memory device; whereby the timing signal is used for determining the value of the information signal; comprising a retiming circuit that is connected with the communication channel, whereby the retiming circuit generates depending on a compensation signal on an input of the retiming circuit a delay between the data path and the timing path for sending an information signal and a timing signal from the controller and the memory device, resulting in a time delay between the timing signal and the information signal.

In still another embodiment of the invention, there is a memory system with a controller and a memory device; with a communication channel with a data path and a timing path coupling the controller with the memory device; whereby the communication channel having different propagation times for the data path and the timing path sending an information signal and a timing signal from the controller to the memory device, whereby the timing signal is used for determining the value of the information signal; with a retiming circuit that is connected with the communication channel, whereby the retiming circuit compensates depending on a compensation signal on an input of the retiming circuit the delay between the data path and the timing path for sending the information signal and the timing signal from the controller to the memory device, whereby the retiming circuit comprises a first interface and a second interface, whereby the first interface is connected by a first data path and a first timing path with the memory controller and the second interface is connected by a second data path and a second timing path with at least one memory device, whereby the retiming circuit exchanges information signals and timing signals with the memory controller by the first interface and exchanges information signals and the timing signals by the second interface with the memory device, whereby the first and the second interface are connected.

In yet another embodiment the invention, there is a memory system with a controller and a memory device; with a communication channel with a data path and a timing path coupling the controller with the memory device; whereby the communication channel having different propagation times for the data path and the timing path sending an information signal and a timing signal from the controller to the memory device; with a retiming circuit that is connected with the timing path, whereby the retiming circuit compensates depending on a compensation signal on an input of the retiming circuit the delay between the data path and the timing path for sending the information signal and the timing signal from the controller to the memory device, whereby the retiming circuit comprises a first interface and a second interface, whereby the first interface is connected by a first timing path with the memory controller and the second interface is connected by a second timing path with at least one memory device, whereby the retiming circuit receives timing signals from the memory controller by the first interface and sends the timing signals by the second interface to the memory device, whereby the first and the second interfaces are connected.

In another embodiment of the invention, there is a method of exchanging data and timing signals between a memory controller and a memory device that are connected by a communication channel with a data path and a timing path; whereby the communication channel having different propagation times for the data path and the timing path sending an a information signal and a timing signal from the controller to the memory device, whereby the timing signal is used for determining the value of the information signal in the memory device; whereby depending on a compensation signal the delay between the data path and the timing path for sending the information signal and the timing signal from the controller to the memory device is reduced to a predetermined range.

In still another embodiment of the invention, there is a method of sending information signals and timing signals from a memory controller to a memory device that are connected by a communication channel with a data path and a timing path; whereby the timing signal is used for determining the value of the information signal in the memory device; whereby depending on a compensation signal a delay between the data path and the timing path for sending the information signal and the timing signal from the controller to the memory device is generated to a predetermined range.

### BRIEF DESCRIPTION OF THE DRAWINGS

The invention is described in more detail below with reference to the exemplary embodiments and drawings, in which:

FIG. 1 shows a first memory system.

FIG. 2 shows a second memory system.

FIG. 3 shows a third memory system.

FIG. 4 shows a fourth memory system.

FIG. 5 shows a fifth memory system.

FIG. 6 shows a retiming circuit in detail.

### DETAILED DESCRIPTION OF THE INVENTION

The present invention may be described in terms of various functional components. It should be appreciated that such functional components may be realized by any number of hardware or structural components configured to conform the specified functions. In addition, the present invention may be practiced in any integrated circuit application. Such general applications which may be appreciated by those skilled in the art in light of the present disclosure are not described in detail. Further, it should be noted that while various components may be suitably coupled or connected to other components within exemplary circuits, such connections and couplings can be realized by varied connections between components and by connections through other components and devices located in between.

The invention refers to a memory system with a controller and a memory device that are connected by a communication channel with a data path and a time path. On the data path information signals and on the time path timing signals are transferred. The data path and the time path have different propagation times and there is a retiming controller that is connected with the data or time path and that is used for controlling the access to the memory device. The access to the memory device is controlled by compensating a delay time between information signals on the data path and timing signals on the time path, whereby the timing signals are used for detecting the value of the information signal in the memory device. The timing signal determines the point of time at which the information signal is sensed. Therefore the precise time relation between the timing signal and the information signal is necessary to detect the information signal correctly.

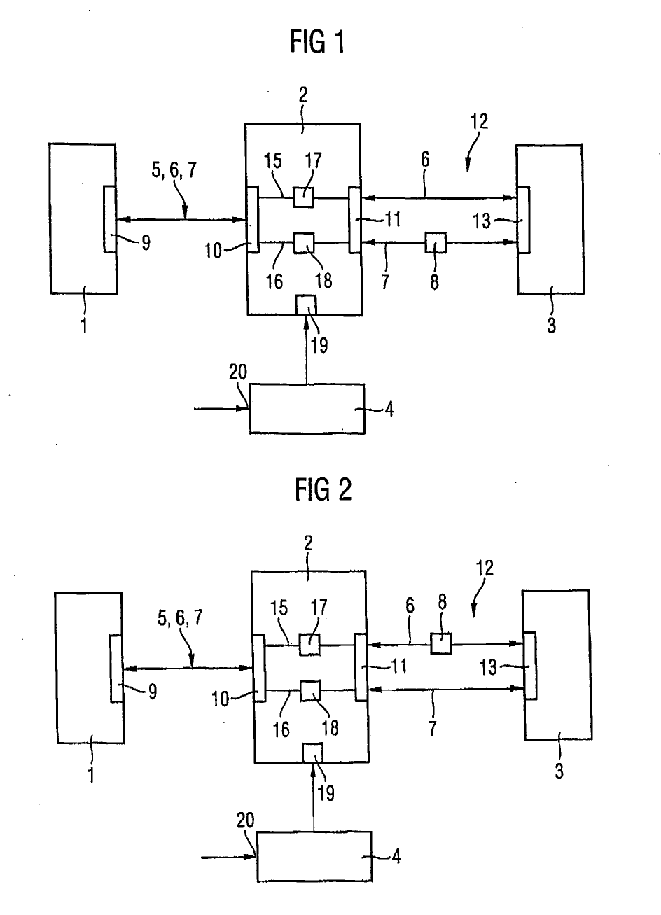

FIG. 1 depicts a schematic view of a first memory system with a memory controller 1 that is connected by a retiming circuit 2 with a memory device 3. The retiming circuit 2 is connected by a controlling line with an arbiter 4. A communication channel 5 is arranged for exchanging data and timing signals between the memory controller 1 and the retiming circuit 2. A further communication channel 12 is arranged for exchanging data and timing signals between the retiming circuit 2 and the memory device 3. The communication channel 5 and the further communication channel 12 comprise a data path 6 and a timing path 7. The data path 6 is used for sending and/or exchanging information signals and the timing path 7 is used for sending and/or exchanging timing signals. The timing signal may be a clock signal with a rectangle wave form, whereby at a positive edge of the rectangle wave form the values of information signals are determined. The timing signal may be a clock signal and/or a data strobe signal. The information signal may be a command signal and/or a control signal and/or an address signal and/or a data signal. Therefore a precise time relation between the information signal and the timing signals in the memory device may be necessary for accessing the memory device 3.

The communication channel 5 and/or the further communication channel 12 may comprise a delay between the data path and the timing path for exchanging information signals and timing signals between the controller 1 and the memory device 3. The delay may be introduced by a delay element 8 that is connected with the data path and/or the timing path. Furthermore, the delay may result of a mismatching of the signal lines of the data path and the timing path. The time delay may be generated by a mismatched printed circuit board routing between the data path and the timing path or by adding an extra load on the conductors timing path for the timing signal.

The memory controller 1 comprises a first interface 9 that is connected with the communication channel 5. The communication channel is guided from the first interface 9 to a second interface 10 that is part of the retiming circuit 2. The second interface 10 is connected with a third interface 11. The third interface 11 is also part of the retiming circuit 2. The third interface 11 is connected with the further communication channel 12 that is guided to a fourth interface 13 that is part of the memory device 3.

In the depicted embodiment, the timing path 7 of the further communication channel 12 comprises a delay that delays the timing signal compared to the information signals of a data path for a predetermined delay time DT. The delay may be generated by technical differences between signal lines of the data path and the timing path. The time delay may however be realized with a delay element 8 that is arranged in the timing path 7.

The second interface 10 is connected with the third interface 11 by a a retiming data path 15 and a retiming timing path 16 that connect the second and third interface 10, 11. The retiming data path 15 may comprise a controllable first delay circuit 17. Additionally, the retiming timing path 16 may comprise a second controllable delay circuit 18. The first delay circuit 17 and the second delay circuit 18 may be controlled by an input signal 19 that is delivered by the arbiter 4 to the retiming circuit 2. Input signal 19 determines whether the delay between the data path and the timing path is compensated by the first or the second delay circuit 17, 18. The retiming circuit 2 and the arbiter 4 constitute a retiming controller that controls the access to the memory device 3 by compensating a delay between the data path and the timing path of the communication channel 5 and/or the further communication channel 12. If the information signals on the data path 6 have a delay greater than a predetermined delay range compared to the timing signals on the timing path 7, then the memory device 3 cannot be accessed for reading or writing data to the memory cells of the memory device 3. It is necessary for the access to the memory device 3 that the information signal and the timing signal have within a time frame predetermined values. If there is a delay between the information signal and the timing signal, then the memory device 3 can not be accessed by the controller 1. The memory device 3 may be a DRAM or a SRAM memory.

Depending on the embodiment, the retiming circuit 2 and the arbiter 4 may be constituted in one retiming controlling device. Furthermore, the retiming circuit 2 may be part of the first interface 9 or the fourth interface 13. If the delay element 8 is arranged in the timing path 7, it might not be necessary to provide a second delay circuit 18 in the retiming timing path 16 of the retiming circuit 2, because the delay may be compensated by using only the first delay circuit 17 of the retiming data path 15 of the retiming circuit 2. In a further embodiment, there might only be disposed the second delay circuit 18 and no first delay circuit 17 for delaying the timing signals. The arbiter 4 may comprise a second input 20 that receives a controlling signal that decides whether the access to the memory device 3 may be granted or not. The input signal to the second input 20 may be delivered by a further controlling device.

The function of the memory system as depicted in FIG. 1 is as follows: The memory controller 1 may access the memory cells of the memory device 3. Thus, the memory controller 1 sends information signals and timing signals with signal values and time relation that correspond to an access to the memory device 3 by the first interface 9 to the second interface 10 of the retiming circuit 2. The retiming circuit 2 delivers the timing signals over the retiming timing path 16 to the third interface 11. From the third interface 11, the timing signals are delivered by the timing path 7 of the further communication channel 12 to the fourth interface 13 of the memory device 3.

The information signals of the memory controller 1 are sent over the communication channel 5 and received by the second interface 10 and then delivered by the retiming data path 15 and the delay circuit 17 to the third interface 11. At the initial state, the arbiter 4 does not grant an access to the memory device 3 and therefore the delay circuit 17 does not delay the information signals on the retiming data path 15 corresponding to the delay that is caused by the delay element 8 on the timing path 7. The information signals are transferred from the third interface 11 to a data path 6 of the further communication channel 12 and sent to the fourth interface 13 of the memory device 3. Because of the delay element 8 that is arranged in the timing path 7, the timing signals are delayed a predetermined delay time compared to the information signals. Therefore the information signals are received earlier by the fourth interface 13. Because of the time delay the information signals cannot be detected correctly, because the timing signal that determines the point of time at which the information signals have to be evaluated is time shifted and therefore wrong information is received by the fourth interface 13. Therefore the memory device does not receive a correct information signal. No access to the memory device 3 is possible. The information signal may be an address signal referring to memory cells that may be accessed or data that may be stored in memory cells.

If the access to the memory device 3 should be allowed, then the arbiter 4 controls the delay circuit 17 by delaying the information signal for a predetermined delay time. The predetermined delay time may be equal to the delay time that is caused by the delay element 8 and the timing path for the timing signals. Therefore in this situation, the information signals are delayed by the first delay circuit 17 for the delay time and therefore the information signals and the timing signals are received by the fourth interface 13 without a relative delay. Therefore it is possible for the fourth interface 13 to determine the information signals on the data path with the correct timing of the timing signals and the controller 1 may access the memory device 3 for reading and/or writing data from or to the memory cells of the memory device 3.

The invention uses the idea of compensating a timing delay between timing signals on a timing path and information signals on a data path. Depending on the embodiment, the timing delay may be introduced by a delay element and compensated by a retiming circuit 2. The retiming circuit 2 may be controlled by an arbiter 4 that allows the access to the memory device or not by adjusting a suitable delay in the retiming device to compensate the delay between the information signal and the timing signal. The retiming device may operate on the timing signal and/or on the information signal and change the relative timing in order to cancel the effects of the delay between the information signal and the timing signal. The retiming circuit 4 may include the arbiter functionality or may communicate with the arbiter 4.

It might not be necessary to provide a delay on all the information signals or all the timing signals. It might be enough to delay a subset of information signals and/or a subset of timing signals to prohibit an access to the memory device 3. Therefore the retiming circuit 2 may also delay only a subset of information signals and/or a subset of timing signals for compensating the delay of the subset of timing signals and/or the subset of information signals.

The invention uses in a further embodiment the idea of generating a timing delay between timing signals on a timing path and information signals on a data path. The timing delay may be generated by a retaining circuit 2. The retiming circuit 2 may be controlled by an arbiter 4 that allows the access to the memory device or not by generating a delay in the retiming device to cause a delay between the information signal and the timing signal in the memory device. The delay results in a wrongly sensing of the information signal. Therefore no access to the memory device may be possible. The retiming device may operate on the timing signal and/or on the information signal and change the relative timing in order to generate the delay between the information signal and the timing signal. The retiming circuit 4 may include the arbiter functionality or may communicate with the arbiter 4.

It might not be necessary to generate a delay on all the information signals or all the timing signals. It might be enough to delay a subset of the signals and/or a subset of the timing signals to prohibit an access to the memory device 3. Therefore the retiming circuit 2 may only delay a subset of information signals and/or a subset of timing signals for generating the delay of the subset of timing signals and/or the subset of information signals.

FIG. 2 depicts a further embodiment, that comprises the delay element 8 in the data path 6 of the further communication channel 12. Furthermore, the retiming timing path 16 may comprise the second delay circuit 18. If the arbiter 4 does not allow the access to the memory device 3, then the second delay circuit 18 does not delay the timing signals relative to the information signals. Therefore the information signals may not be determined correctly by the memory device 3, because there is a time shift between the timing signals and the information signals. The timing signals may be a clock and/or a data strobe signal. The information signal may be a data signal and/or a command signal and/or an address signal and/or a control signal.

The information signals may represent different types of data information. For example using a dynamic random access memory, the information signal may be command signals as for example a RAS signal or a R/W signal or a CAS signal. The information signal may be a simple high or low voltage level. The timing signal may be a clock signal CK in example a rectangle alternating clock signal. Furthermore the information signal may be an address signal for a memory cell of the dynamic random access memory or at least a part of an address signal, for example the row address or the column address of the memory cell of the DRAM. If the timing signal is not in the right timing position relative to the information signal for example the column address or any other command signal of the DRAM, then the DRAM cannot be accessed correctly. Therefore it is possible by using the retiming device 2 to allow or to prohibit the access to the memory device 3 by compensating a time delay between the timing signal and the information signal.

For example it is not necessary for a DRAM, that the clock signal is always in a timing imbalance for prohibiting the access to the memory device. It might be enough to have a time delay between the correct timing position of the information signal and the timing signal for a predetermined part of the information signal, for example the RAS or the CAS or the R/W signal. Furthermore, it might be useful to use different time delays for different information signals. Depending on the information signal different time delays might be necessary to prohibit the access to the memory device.

The timing delay might be added by the communication channel 5 or by a delay element 8 that might also be part of the retiming circuit 2. Depending on the embodiment, the delay element may be part of an interface between the controller 1 and the retiming circuit 2 or between the retiming circuit 2 and the memory device 3. Furthermore it is possible to use a delay element on the two sides of the interfaces of the retiming device 2. If there is a delay element 8 used for generating the delay between the timing signal and the information signal, then the delay time is known by the retiming circuit 2 and the delay between the information signal and the timing signal may be compensated by shutting of the delay element 8.

The delay element 8 may be connected to the communication channel 5 using switches and therefore depending on the position of the switches, the delay element 8 might be a part of the communication channel 5 or not. In this situation, it is not necessary to know the actual time delay between the data path and the timing path of the communication channel.

The delay element 8 may be constituted by a programmable delay element 8 with a programmable delay time. Therefore it might be possible to use a different delay time with the same delay element 8 for different information signals and/or different timing signals. The time delay of the delay element 8 may be determined by the retiming circuit 2 or the arbiter 4.

In a further embodiment, the retiming circuit 2 may comprise a phase locked loop circuit (PLL) or a delay locked loop circuit (DLL). The phase locked loop circuit or the delay locked loop circuit may be connected with the data path and the timing path. The PLL, circuit and DLL circuit may be controlled by the retiming circuit 2 by generating a time delay between the data path and the timing path or to compensate a time delay between the data path and the timing path. The PLL or the DLL circuit are simple means for generating or compensating a delay between the data path and the timing path. In some embodiments it might be of advantage to use some training mechanism to find out a proper timing for prohibiting or allowing an access to the memory device 3. The time delay may vary for different types of memory devices 3 and/or different types of information signals and timing signals. Therefore it might be useful to determine the proper time delay between the data path and the timing path for prohibiting or for allowing an access to the memory device 3. The PLL circuit and/or DLL circuit may be controlled to generate or to compensate a delay between a timing signal and an information signal.

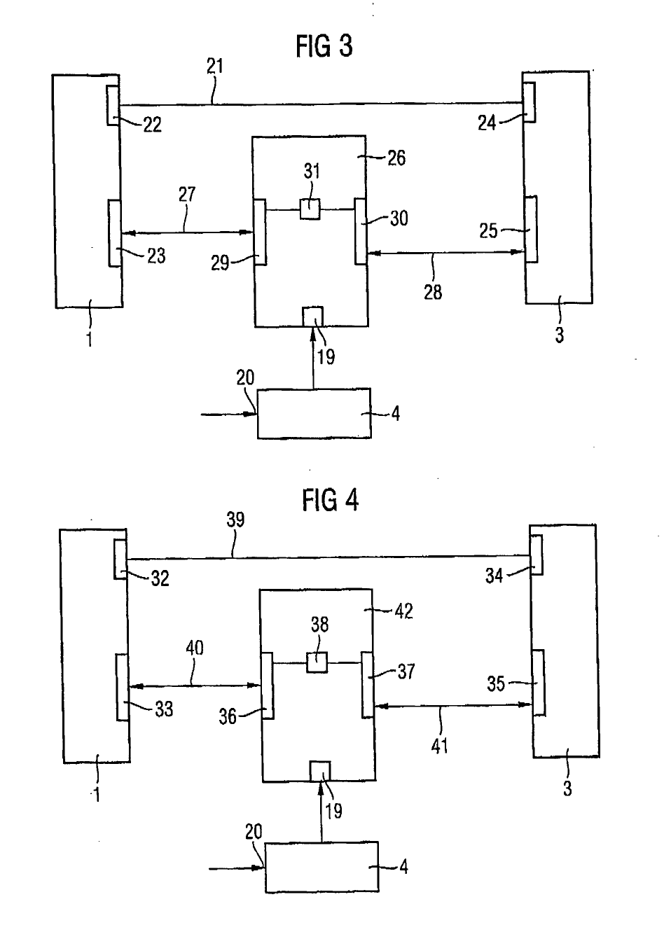

FIG. 3 depicts a third embodiment with a further data path 21 that is directly guided from the controller 1 to the memory device 3. The controller 1 comprises a further first interface 22 that is connected to the further data path 21. The further data path 21 is connected with a further third interface 24 of the memory device 3. The controller 1 comprises a further second interface 23 that is connected with a further first timing path 27. The further first timing path 27 is connected with a further fifth interface 29 of a further retiming circuit 26. The further retiming circuit 26 comprises a further sixth interface 30 that is connected with a further second timing path 28. The further second timing path 28 is guided to a further fourth interface 25 of the memory device 3.

The further retiming circuit 26 is connected by an input signal 19 with an arbiter 4. In this embodiment, only the timing path and the timing signals or at least a part of the timing signals are guided through the further retiming circuit 26. The further retiming circuit 26 comprises a further delay circuit 31 that may be controlled by the arbiter 4 and that connects the further fifth interface 29 with the further sixth interface 30. This embodiment has the advantage that it is not necessary to provide an interface at the further retiming circuit 26 for the transmission of the information signals and for the further data path 21.

Depending on the embodiment whether there is a delay between the exchange of information signals on the further data path 21 compared to the exchange of timing signals of the further timing paths 27, 28 between the controller 1 and the memory device 3, the further retiming circuit 26 may have the task to generate the delay for prohibiting an access from the controller 1 to the memory device 3. Alternatively the further retiming circuit 26 may have the task to compensate a delay between the further data path 21 and the further first and second timing paths 27, 28. If there is no connection between the data path and the further retiming circuit 26, then it is necessary that the delay between the further data path 21 and the further first and/or second timing path 27, 28 is known to the further retiming circuit 26 or the arbiter 4 to control the time delay that might be generated or compensated by the further delay circuit 31. The further delay circuit 31 may be constituted by a delay circuit with a controllable delay time. Therefore it might be possible to use different delay times for different pairs of data and timing signals and/or for different memory devices.

In a fourth embodiment as shown in FIG. 4, only the information signals or at least a part of the information signals are transferred by a further second retiming circuit 42 from the controller 1 to the memory device 3 and vice versa. The timing signal is guided in this embodiment directly from the controller 1 to the memory device 3. The controller 1 comprises a further seventh interface 32 that is connected with a further third timing path 39. The further third timing path 39 is directly guided from the controller 1 to a further ninth interface 34 of the memory device 3. Furthermore, the controller 1 comprises a further eighth interface 33 that is connected with a further first data path 40. The further first data path 40 is guided to a further eleventh interface 36 of a further second retiming circuit 42. The further second retiming circuit 42 comprises a further second delay circuit 38 that is connected with the further eleventh interface 36 and a further twelfth interface 37. The further twelfth interface 37 is connected with a further second data path 41. The further second data path 41 is connected with a further tenth interface 35 of the memory device 3. The further second retiming circuit 42 is connected by a control signal 19 with an arbiter 4. The further second delay circuit 38 may be constituted as a delay circuit with a controllable delay time. If there is a delay between the further third timing path 39 and the further first and second data paths 40, 41 for an exchange of timing signals and information signals between the controller 1 and the memory device 3, then the arbiter 4 may control the further second delay circuit 38 to compensate the delay for allowing an access to the memory device 3 by the controller 1.

If there is basically no time delay between the further third timing path 39 and the further first and second data paths 40, 41 between the controller 1 and the memory device 3 for exchanging timing signals and information signals, then the arbiter 4 may generate a delay by controlling the further second delay circuit 38 for denying and prohibiting an access to the memory device 3 by the controller 1.

Also in this embodiment if there is basically a delay between the further third timing path 39 and the further first and second data paths 40, 41 between the controller 1 and the memory device 3, the time delay has to be known by the arbiter 4 so it is possible for the arbiter 4 to compensate by controlling the further second delay circuit 48 to compensate the delay time.

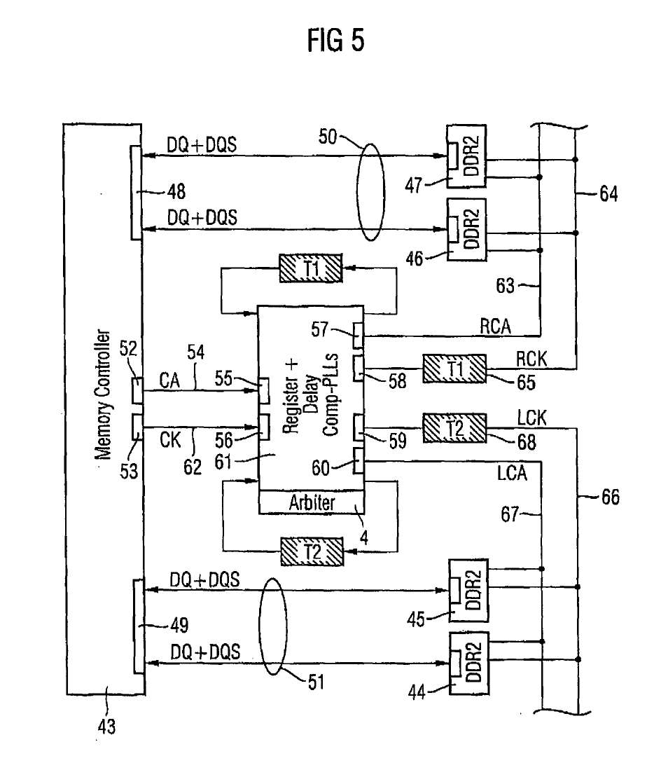

FIG. 5 depicts a memory system with a memory subsystem comprising a further memory controller 43, a further first, second, third and fourth memory device 44, 45, 46, 47. The further first, second, third and fourth memory device 44, 45, 46, 47 may be constituted by a dynamic random access memory for example by a DDR2 memory device. The further memory controller 43 comprises a first and a second additional interface 48, 49 that are connected with a first and a second data bus 50, 51. The first data bus 50 is connected with the further third memory device 46 and the further fourth memory device 47. The second data bus 51 is connected with the further first memory device 44 and the further second memory device 45. The first and the second data bus 50, 51 are used to exchange bidirectional data signals DQ and in some embodiments data strobe signals DQS. The further first, second, third, fourth memory devices 44, 45, 46, 47 comprise respective interfaces for receiving and transmitting information signals and data strobe signals DQS.

The further memory controller 43 comprises a third additional interface 52 and a fourth additional interface 53. The third additional interface 52 is connected with an additional data path 54 that is guided to a fifth additional interface 55 of an additional retiming circuit 61. The further memory controller 43 comprises a fourth additional interface 53 that is connected with an additional timing path 62. The additional timing path 62 is guided to a sixth additional interface 56 of the additional retiming circuit 61.

The additional retiming circuit 61 comprises a seventh additional interface 57 that is connected with a first address bus 63. The first address bus 63 is connected with the further fourth and third memory device 47, 46. The additional retiming circuit 61 comprises an eighth additional interface 58 that is connected with a first clock line 64. The first clock line 64 is connected with the further third or fourth memory device 46, 47. Depending on the used embodiment, there might be an additional delay element 65 in the first clock line 64. The additional delay element 65 may delay a clock signal for a first delay time T1.

The additional retiming circuit 61 comprises a ninth additional interface 59 that is connected with a second clock line 66. The second clock line 66 is connected with the further first and second memory device 44, 45. The additional retiming circuit 61 comprises a tenth additional interface 60 that is connected with a second address bus 67. The second address bus 67 is connected with the further first and second memory device 44, 45. Depending on the used embodiment, there might be an additional second delay element 68 in the second clock line 66. The second additional delay element 68 delays the clock signal for a second delay time T2. In further embodiments, the first and/or the second delay time T1, T2 may be generated by technical differences between the first address bus 63 and the first clock line 64 or between the second address bus 67 and the second clock line 66.

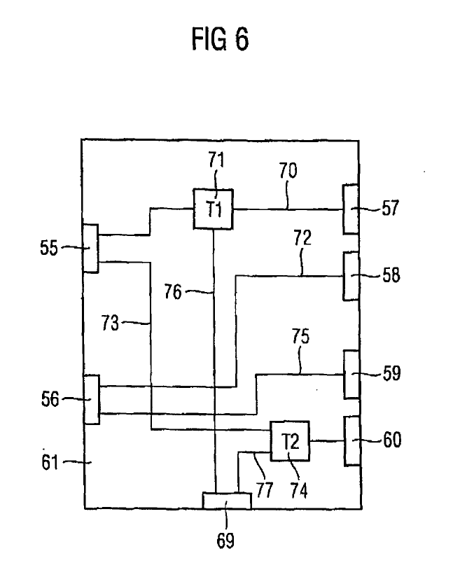

FIG. 6 depicts in greater detail the additional retiming circuit 61 with a further arbiter 69. The fifth additional interface 55 is connected by a first line 70 with the seventh additional interface 57. In the first line 70, an additional first delay circuit 71 may be arranged. The sixth additional interface 56 is connected with a second line 72 with the eighth additional interface 58. Furthermore, the fifth additional interface 55 is connected with a third line 73 that may be guided over an additional second delay circuit 74 to the tenth additional interface 60. The sixth additional interface 56 is connected by a fourth line 75 with the ninth additional interface 59.

The additional first delay circuit 71 and the additional second delay circuit 74 are connected by control lines 76, 77 with the further arbiter 69. The further arbiter 69 controls the additional first and second delay circuit 71, 74. In one embodiment the additional delay element 65 generating a first delay time T1 is disposed in the first clock line 74. Thus, the timing signals on the first clock line 64 are delayed for the first delay time T1 compared to information signals on the first address bus 63. If there is a time shift between the information signals of the first address bus 63 and the timing signals on the first clock line 64, then the further third and fourth memory device 46, 47 may not be correctly addressed by the further memory controller 43. Therefore it is not possible for the further memory controller 43 to read or write information from or to the further third and fourth memory device 46, 47. Therefore the further memory controller 43 is prohibited to access the further third and fourth memory device 46, 47.

If the further arbiter 69 allows an access from the further memory controller 43 to the further third and fourth memory device 46, 47, then the further arbiter 69 controls the additional first delay circuit 71 to delay the information signals for the first delay time T1. Therefore, the information signals and the timing signals of the first address bus 63 and the first clock line 64 are put in the correct time relation. Then the further third and fourth memory device 46, 47 can detect the information signals on the first address bus 63 correctly. Therefore it is possible to exchange data information over the first data bus 50 between the further memory controller 43 and the further third and fourth memory device 46, 47.

If there is the second additional delay element 68 in the second clock line 66, then the timing signals on the second clock line 66 are delayed for a second delay time T2. This results in a time shifting between the information signals and the timing signals. Therefore the further first and second memory device 44, 45 are not able to determine correctly the information signals on the second address bus 67. Therefore it is not possible for the further memory controller 43 to address the further first and second memory device 44, 45. If the further arbiter 69 allows an access of the further memory controller 43 to the further first and second memory device 44, 45, then the further arbiter 69 controls the additional second delay circuit 74 to delay the information signals on the third line 73 for a second delay time T2. This results in a time shifting of the information signals on the second address bus 67 resulting in a correct timing of the information signals of the second address bus 67 and the timing signals on the second clock line 66. Therefore it is possible for the further first and second memory device 44, 45 to determine the information signals correctly. Thus it is possible for the further memory controller 43 to access the further first and second memory device 44, 45 and to read or to write data over the second data bus 51 to or from the further first and second memory device 44, 45.

The additional first and second delay circuit 71, 74 may be constituted by a phase locked loop circuit or a delay locked loop circuit or any other circuit that may be controlled for generating a time delay for a timing signal and/or an information signal.

If there is no additional delay element 65 and no additional second delay element 68 in the first clock line 64 or respectively in the second clock line 66, then the further arbiter 69 may use the additional first delay circuit 71 and/or the additional second delay circuit 74 to introduce a relative time shifting in the information signals compared to timing signals between the first address bus 63 and the first clock line 64 or between the second clock line 66 and the second address bus 67. If the further arbiter 69 delays the information signals compared to the timing signals, then it is not possible to access the further first, second, third and/or fourth memory device 44, 45, 46, 47 by the further memory controller 43.

If the further arbiter 69 allows an access of the further memory controller 43 to the further first, second, third and/or fourth memory device 44, 45, 46, 47, then the further arbiter 69 controls the additional first delay circuit 71 and the additional second delay circuit 74 to reduce the delay time to the value zero. Thus resulting in a correct relative timing between the information signals and the timing signals on the first address bus 63 and the first clock lines 64 and a correct relative timing between the information signals of the second address bus 67 and the timing signals on the second clock line 66. Then the further memory controller 43 is able to access the further first, second, third and fourth memory device 44, 45, 46, 47 by to read and/or to write data from or to the further first, second, third and/or fourth memory device.

Depending on the embodiment, the additional first delay circuit 71 may not be arranged in the first line 70 but in the second line 72. Additionally, the additional second delay circuit 74 may not be arranged in the third line 73 but in the fourth line 75. This embodiment may be used, if a control of a delay of the timing signal might be preferred. Furthermore, the control of a delay of the timing signal on the timing path, in this embodiment the first clock line 64 and the second clock line 66 may be used, if there is no delay between the information signals and the timing signals. As a result, the further arbiter 69 may use the additional first delay circuit 71 and/or the additional second delay circuit 74 for controlling a relative time delay between the information signals on the first address bus 63 compared to the timing signals on the first clock line 64 or between the information signals on the second address bus 67 compared to the timing signals on the second clock line 66. In this embodiment the further arbiter 69 prohibits an access to the further first, second, third, fourth memory device 44, 45, 46, 47 by introducing a delay in the second and fourth line 72, 75. If the further arbiter would like to allow an access of the further memory controller 43 to the further first, second, third and/or fourth memory device 44, 45, 46, 47 it controls the additional first and second delay circuit 71, 74 to generate no time delay for the timing signals. Using this embodiment, it is possible to allow or prohibit an access to the further memory devices by controlling a delay of the timing signals relative compared to information signals.

What is claimed is:

1. A memory system with a controller and a memory device, comprising:
a communication channel with a data path and a timing path coupling the controller with the memory device, wherein the communication channel has different propagation times for the data path and the timing path exchanging an information signal and a timing signal between the controller and the memory device, and the timing signal is used for determining the value of the information signal; and
a retiming circuit connected with the communication channel, wherein the retiming circuit compensates, depending on a compensation signal on an input of the retiming circuit, the delay between the data path and the timing path for sending an information signal and a timing signal from the controller to the memory device.

2. A memory system with a controller and a memory device, comprising:
a communication channel with a data path and a timing path coupling the controller with the memory device, wherein the timing signal is used for determining the value of the information signal; and
a retiming circuit that is connected with the communication channel, wherein the retiming circuit generates, depending on a compensation signal on an input of the retiming circuit, a delay between the data path and the timing path for sending an information signal and a timing signal from the controller and the memory device, thereby resulting in a time delay between the timing signal and the information signal.

3. The memory system according to claim 1, wherein the communication channel comprises a data bus as a data path.

4. The memory system according to claim 1, wherein the communication channel comprises a signal line as a timing path.

5. The memory system according to claim 1, wherein the timing signal comprises a clock signal.

6. The memory system according to claim 1, wherein the timing signal comprises a data strobe signal.

7. The memory system according to claim 1, wherein the information signal comprises at least a part of an address of a memory cell.

8. The memory system according to claim 1, wherein the information signal comprises at least a part of a data signal.

9. The memory system according to claim 1, wherein the information signal comprises at least a part of a control signal.

10. The memory system according to claim 1, wherein the information signal comprises at least a part of a command signal.

11. The memory system according to claim 1, wherein the retiming circuit delays the signals of the faster path for reducing the delay between the timing path and the signal path to a predetermined value.

12. The memory system according to claim 1, wherein the input of the retiming circuit is connected with an arbiter unit, and the arbiter unit controls the retiming circuit for compensating the delay between the timing path and the data path between the controller and the memory device by a compensation signal that is put on the input of the retiming circuit.

13. The memory system according to claim 2, wherein the input of the retiming circuit is connected with an arbiter unit, and the arbiter unit controls the retiming circuit for generating a delay between the timing path and the data path between the controller and the memory device by a signal that is put on the input of the retiming circuit.

14. The memory system according to claim 1, wherein the retiming circuit comprises a phase locked loop circuit connected with the communication channel and compensates the delay between a information signal on the data path and a timing signal on the timing path for exchanging the information signal and the timing signal between the controller and the memory device.

15. The memory system according to claim 2, wherein the retiming circuit comprises a phase locked loop circuit connected with the communication channel and generates the delay between a information signal on the data path and a timing signal on the timing path for exchanging the information signal and the timing signal between the controller and the memory device.

16. The memory system according to claim 1, wherein the retiming circuit comprises a delay locked loop circuit connected with the communication channel and compensates a delay of a information signal and a timing signal that are sent from the controller to the memory device.

17. The memory system according to claim 2, wherein the retiming circuit comprises a delay locked loop circuit connected with the communication channel and generates a delay of a information signal and a timing signal that are sent from the controller to the memory device.

18. The memory system according to claim 14, wherein the phase locked loop circuit is controlled by the arbiter unit.

19. The memory system according to claim 16, wherein the delay locked loop circuit is controlled by the arbiter unit.

20. The memory system according to claim 1, further comprising a second memory device connected with the data path for exchanging data with the memory controller, wherein the second memory device is connected with the timing path for receiving timing signals, the data path and the timing path have different propagation times for exchanging a information signal between the memory controller and the second memory device and for exchanging a timing signal between the memory controller and the second memory device, and the retiming circuit comprises an input where the retiming circuit compensates depending on a compensation signal on the input the delay between the timing signal and the information signal that are sent from the memory controller to the second memory device.

21. The memory system according to claim 20, wherein the input of the retiming circuit is connected with an arbiter unit, and the arbiter unit controls the retiming circuit for compensating the delay between a timing signal and a information signal that are exchanged between the memory controller and the first or second memory device by a compensation signal that is put on the input of the retiming circuit.

22. A memory system with a controller and a memory device, comprising:
a communication channel with a data path and a timing path coupling the controller with the memory device, wherein the communication channel having different propagation times for the data path and the timing path sending an information signal and a timing signal from the controller to the memory device, and the timing signal is used for determining the value of the information signal; and
a retiming circuit connected with the communication channel, wherein the retiming circuit compensates depending on a compensation signal on an input of the retiming circuit the delay between the data path and the timing path for sending the information signal and the timing signal from the controller to the memory device, wherein the retiming circuit comprises:
a first interface and a second interface, the first interface connected by a first data path and a first timing path with the memory controller and the second interface connected by a second data path and a second timing path with at least one memory device, wherein the retiming circuit exchanges information signals and timing signals with the memory controller by the first interface and exchanges information signals and the timing signals by the second interface with the memory device, and the first and the second interface are connected.

23. The memory of claim 22, wherein the second interface is connected by a third data path and by a the third timing path with a second memory device, the retiming circuit exchanges information signals and timing signals with the memory controller by the first interface and the retiming circuit exchanges information signals and the timing signals by the second interface with the first and second memory device, wherein the first and the second interface are connected.

24. A memory system with a controller and a memory device, comprising:
a communication channel with a data path and a timing path coupling the controller with the memory device, wherein the communication channel has different propagation times for the data path and the timing path sending an information signal and a timing signal from the controller to the memory device; and
a retiming circuit connected with the timing path, wherein the retiming circuit compensates depending on a compensation signal on an input of the retiming circuit the delay between the data path and the timing path for sending the information signal and the timing signal from the controller to the memory device, wherein the retiming circuit comprises:
a first interface and a second interface, wherein the first interface is connected by a first timing path with the memory controller and the second interface is connected by a second timing path with at least one memory device, the retiming circuit receives timing signals from the memory controller by the first interface and sends the timing signals by the second interface to the memory device, and the first and the second interfaces are connected.

25. The memory of claim 24, wherein the second interface is connected by a third data path and by a third timing path with a second memory device, the retiming circuit receives information signals and timing signals from the memory controller by the first interface and the retiming circuit sends information signals and the timing signals by the second interface to the first and second memory device, and the first and the second interface are connected.

26. A method of exchanging data and timing signals between a memory controller and a memory device connected by a communication channel with a data path and a timing path, with the communication channel having different propagation times for the data path and the timing path, comprising:
sending an a information signal and a timing signal from the controller to the memory device; and
using the timing signal to determine the value of the information signal in the memory device, wherein depending on a compensation signal, the delay between the data path and the timing path for sending the information signal and the timing signal from the controller to the memory device is reduced to a predetermined range.

27. A method of sending information signals and timing signals from a memory controller to a memory device connected by a communication channel with a data path and a timing path, comprising:
using the timing signal to determine the value of the information signal in the memory device; and
depending on a compensation signal, generating a delay between the data path and the timing path for sending the information signal and the timing signal from the controller to the memory device is generated to a predetermined range.

28. The method of claim 26, wherein the delay is determined, and depending on the compensation signal, is reduced to the predetermined range.

29. The method of claim 26, wherein the data path comprises a delay and the timing signal is delayed to reduce the delay to a predetermined range.

30. The method of claim 26, wherein the information signals is at least a part of an address of a memory cell.

31. The method of claim 26, wherein the information signal is at least a part of a command signal.

32. The method of claim 26, wherein the information signal is at least a part of a data signal.

33. The method of claim 26, wherein the information signal is at least a part of a control signal.

34. The method of claim 26, wherein the timing signal is at least a part of a clock signal.

35. The method of claim 26, wherein the timing signal is at least a part of a data strobe signal.
